(19) United States
(12) Patent Application Publication
(10) Pub. No.: US 2025/0219366 A1
(43) Pub. Date: Jul. 3, 2025

(54) CABLE SPLICING DEVICE HAVING CABLE INTERFACE PORTS THAT ARE CONFIGURED TO BE ROTATED RELATIVE TO ONE ANOTHER SO AS TO IMPROVE INSTALLATION VERSATILITY AND/OR ELECTRICAL PERFORMANCE

(71) Applicant: PPC BROADBAND, INC., East Syracuse, NY (US)

(72) Inventor: Henry Sauvain, Syracuse, NY (US)

(73) Assignee: PPC BROADBAND, INC., East Syracuse, NY (US)

(21) Appl. No.: 19/004,653

(22) Filed: Dec. 30, 2024

Related U.S. Application Data
(60) Provisional application No. 63/615,483, filed on Dec. 28, 2023.

(51) Int. Cl. H02G 1/14

(52) U.S. Cl. CPC H02G 1/14

(57) ABSTRACT

A cable splicing device may include a first portion having a first connection portion structurally configured to connect to a first communication cable and a second portion having a second connection portion structurally configured to connect to a second communication cable. The second portion may be structurally configured to rotate relative to the first portion to adjust an angular orientation of the second connecting portion relative to the first connecting portion so as to permit adjustment of an angular orientation of the first connecting portion relative to the second connecting portion and improve installation versatility and electrical performance.

### CROSS-REFERENCE TO RELATED APPLICATION

This application claims the benefit of U.S. Provisional Patent Application No. 63/615,483, filed on Dec. 28, 2023, the disclosure of which is hereby incorporated by reference herein in its entirety.

### TECHNICAL FIELD

The present disclosure relates generally to hardline cable splicing devices, and more particularly to a hardline cable splicing device having cable interface ports that are configured to be rotated relative to one another so as to improve installation versatility and/or improve electrical performance.

### BACKGROUND

Hardline splice blocks are used to connect two coaxial cables. Some conventional hardline splice blocks have four fixed ports. One port is used as an inlet port and the other three ports are outlet ports that allow the outlet cable to be positioned in any one of three fixed orientations. That is, the four ports provide only three installation options for orienting cables (i.e., a “thru” orientation splice, a 90-degree orientation splice, and a 180-degree orientation splice). In some situations, an installer may prefer to align an input cable and an output cable at a different orientation than the three fixed orientations provided by the conventional splice block. In some cases, an installer may be able to vary the orientation of the input and output cable by using two 90-degree adapters to create different angle combinations. However, such a modified installation adds time to the installation process and requires the installer to stock additional parts, e.g., the 90-degree adapters. Further, such a modified installation may result in a modified splice block that is undesirably larger than the original splice block.

Further, due to the nature of the conventional hardline splice block, two outlet ports are unused because only two ports (one inlet and one outlet) can be used. The unused ports and corresponding internal components configured for forming an electrical coupling act as antennae, which may result in a degraded signal quality.

There is a need for simple splice device that provides multiple port orientations. Accordingly, it may be desirable to provide a cable splicing device including cable interface ports that are configured to be rotated relative to one another such that the cable interface ports are permitted to be aligned in various angular orientations so as to enhance installation.

### SUMMARY

The present disclosure provides a cable splicing device having cable interface ports that are configured to be rotated relative to one another to permit adjustment of a relative orientation of the cable interface ports so as to improve installation versatility and/or improve electrical performance. In some embodiments, the cable splicing device may include a first portion structurally configured to couple to a second portion opposite the first portion. In some embodiments, the second portion may be structurally configured to rotate relative to the first portion.

In some embodiments, the first portion may include a first proximal end portion and a first distal end portion and the second portion may include a second proximal end portion and a second distal end portion opposite the second proximal end portion.

In some embodiments, the first proximal end portion may have a first connecting portion structurally configured to connect to a first communication cable. In some embodiments, the second distal end portion may have a second connecting portion structurally configured to connect to a second communication cable.

In some embodiments, the first distal end portion may be structurally configured to couple to the second proximal end portion.

In some embodiments, the second portion may be structurally configured to rotate relative to the first portion to adjust an angular orientation of the second connecting portion relative to the first connecting portion so as to permit adjustment of an angular orientation of the first connecting portion relative to the second connecting portion and to improve installation versatility and/or improve electrical performance

In some embodiments, the first connecting portion may include a first female port and a first pin receiving portion structurally configured to couple to a first male end portion of the first communication cable. In some embodiments, the second connecting portion may include a second female port and a second pin receiving portion structurally configured to couple to a second male end portion of the second communication cable.

In some embodiments, the cable splicing device may include a locking portion structurally configured to resist rotation of the second portion relative to the first portion.

In some embodiments, the locking portion may include a stop portion associated with the second portion and structurally configured to engage the first portion to prevent rotation of the second portion relative to the first portion.

In some embodiments, the second proximal end portion of the second portion may be structurally configured to be received within a coupling port of the first distal end portion of the first portion.

In some embodiments, the second proximal end portion may be structurally configured to be retained within the coupling port by a retaining portion.

In some embodiments, the first portion may include a first conducting portion having a first proximal end structurally configured to electrically couple to the first pin receiving portion and a first distal end portion opposite the first proximal end portion. In some embodiments, the second portion may include a second conducting portion having a second distal end portion structurally configured to electrically couple to the second pin receiving portion and a second proximal end portion opposite the second distal end portion.

In some embodiments, the first distal end portion of the first conducting portion may be structurally configured to electrically couple to the second proximal end portion of the second conducting portion.

In some embodiments, the first proximal end portion may have a first longitudinal axis and the first distal end portion may have a second longitudinal axis that extends at an angle in the range of 80 degrees to 100 degrees from the first longitudinal axis.

In some embodiments, the second portion may be structurally configured to rotate relative to the first portion about the second longitudinal axis.

In some embodiments, a cable splicing device may include cable interface ports that are configured to be rotated relative to one another to permit adjustment of a relative orientation of the cable interface ports.

In some embodiments, the cable splicing device may include a first portion having a first proximal end portion and a first distal end portion opposite the first proximal end portion and a second portion having a second proximal end portion and a second distal end portion opposite the second proximal end portion. In some embodiments, the first proximal end portion may be structurally configured to connect to a first communication cable and the second distal end portion may be structurally configured to connect to a second communication cable.

In some embodiments, the first proximal end portion may include a first female port and a first pin receiving portion structurally configured to connect to a first male end of the first communication cable.

In some embodiments, the second distal end portion may include a second female port and a second pin receiving portion structurally configured to connect to a second male end of the second communication cable.

In some embodiments, the first portion and the second portion may be structurally configured to electrically couple the first communication cable with the second communication cable.

In some embodiments, cable splicing device may include a locking portion structurally configured to resist rotation of the second portion relative to the first portion. In some embodiments, the locking portion may include a stop portion threadedly coupled to the second portion and structurally configured to engage the first portion to prevent rotation of the second portion relative to the first portion.

In some embodiments, the second proximal end portion of the second portion may be structurally configured to be received within a coupling port of the first distal end portion of the first portion.

In some embodiments, the second proximal end portion may be structurally configured to be retained within the coupling port by a retaining portion.

In some embodiments, the first portion may include a first conducting portion having a first proximal end portion and a first distal end portion opposite the first proximal end portion. In some embodiments, the first proximal end portion of the first conducting portion may be structurally configured to electrically couple to the first pin receiving portion. In some embodiments, the second portion may include a second conducting portion having a second proximal end portion and a second distal end portion opposite the second proximal end portion. In some embodiments, the second distal end portion of the second conducting portion is structurally configured to electrically couple to the second pin receiving portion.

In some embodiments, the first distal end portion of the first conducting portion may be structurally configured to electrically couple to the second proximal end portion of the second conducting portion.

In some embodiments, the first distal end portion of the first conducting portion may include a recessed portion structurally configured to receive the second proximal end portion of the second conducting portion.

In some embodiments, the second portion may be structurally configured to rotate relative to the first portion to adjust an angular orientation of the second female port relative to the first female port so as to permit adjustment of an angular orientation of the first female port relative to the second female port and to improve installation versatility and/or improve electrical performance.

In some embodiments, the first proximal end portion may have a first longitudinal axis, the first distal end portion may have a second longitudinal axis that extends at an angle in the range of 80 degrees to 100 degrees from the first longitudinal axis.

In some embodiments, the second distal end portion may have a third longitudinal axis, and the second proximal end portion may have a fourth longitudinal axis that extends at an angle in the range of 80 degrees to 100 degrees from the third longitudinal axis.

In some embodiments, the second portion may be structurally configured to rotate relative to the first portion about the second longitudinal axis.

In some embodiments, the second longitudinal axis and the fourth longitudinal axis may be coaxial.

In some embodiments, a cable splicing device may have having connecting portions that are structurally configured to be rotated relative to one another to permit adjustment of a relative orientation of the connecting portions.

In some embodiments, the cable splicing device may include a first portion having a first proximal end portion and a first distal end portion opposite the first proximal end portion and a second portion having a second proximal end portion and a second distal end portion opposite the second proximal end portion.

In some embodiments, the first proximal end portion may have a first connecting portion structurally configured to connect to a first communication cable and the second distal end portion may have a second connecting portion structurally configured to connect to a second communication cable.

In some embodiments, the first distal end portion may be structurally configured to couple to the second proximal end portion.

In some embodiments, the first portion and the second portion may be structurally configured to electrically couple the first communication cable with the second communication cable.

In some embodiments, first connecting portion may include first female port and a first pin receiving portion structurally configured to connect to a first male end portion of the first communication cable. In some embodiments, the second connecting portion may include a second female port and a second pin receiving portion structurally configured to connect to a second male end portion of the second communication cable.

In some embodiments, the first portion may include a first conducting portion having a first proximal end portion and a first distal end portion opposite the first proximal end portion. In some embodiments, the first proximal end portion of the first conducting portion may be structurally configured to electrically couple to the first pin receiving portion.

In some embodiments, the second portion may include a second conducting portion having a second proximal end portion and a second distal end portion opposite the second proximal end portion. In some embodiments, the second distal end portion of the second conducting portion may be structurally configured to electrically couple to the second pin receiving portion.

In some embodiments, the first distal end portion of the first conducting portion may be structurally configured to electrically couple to the second proximal end portion of the second conducting portion.

In some embodiments, the second portion may be structurally configured to rotate relative to the first portion to adjust an angular orientation of the second connecting portion relative to the first connecting portion so as to permit adjustment of an angular orientation of the first connecting portion relative to the second connecting portion and provide enhanced electrical performance.

In some embodiments, the first proximal end portion may have a first longitudinal axis and the first distal end portion may have a second longitudinal axis that extends at an angle in the range of 80 degrees to 100 degrees from the first longitudinal axis.

In some embodiments, the second portion may be structurally configured to rotate relative to the first portion about the second longitudinal axis.

In some embodiments, the second distal end portion may have a third longitudinal axis and the second proximal end portion may have a fourth longitudinal axis that extends at an angle in the range of 80 degrees to 100 degrees from the third longitudinal axis.

In some embodiments, the cable splicing device may include a locking portion structurally configured to resist rotation of the second portion relative to the first portion.

In some embodiments, the second proximal end portion of the second portion may be structurally configured to be received within a coupling port of the first distal end portion of the first portion. In some embodiments, the second proximal end portion may be structurally configured to be retained within the coupling port by a retaining portion.

Various aspects of the system, as well as other embodiments, objects, features and advantages of this disclosure, will be apparent from the following detailed description of illustrative embodiments thereof, which is to be read in conjunction with the accompanying drawings.

### BRIEF DESCRIPTION OF THE DRAWINGS

The accompanying drawings, which are incorporated in and constitute a part of this specification, illustrate embodiments of the present teachings and together with the description, serve to explain the principles of the present teachings.

FIG. 1 is a schematic illustration of a cable splicing device and two cables.

FIG. 2 is a perspective view of an example cable splicing device in a first orientation.

FIG. 3 is a section view of the cable splicing device of FIG. 2.

FIG. 4 is a section view of the cable splicing device of FIG. 2 with a male cable connector connected to the device.

FIG. 5 is a perspective view of the cable splicing device of FIG. 2 in a second orientation.

FIG. 6 is a perspective view of the cable splicing device of FIG. 2 in a third orientation.

FIG. 7 is a partial perspective view of a locking portion for a cable splicing device.

FIG. 8 is a base ring of the locking portion of FIG. 7.

### DETAILED DESCRIPTION

Reference will now be made in detail to presently preferred embodiments and methods of the present disclosure, which constitute the best modes of practicing the present disclosure presently known to the inventors. The figures are not necessarily to scale. It is to be understood, however, that the disclosed embodiments are merely exemplary of the present disclosure that may be embodied in various and alternative forms. Therefore, specific details disclosed herein are not to be interpreted as limiting, but merely as a representative basis for any aspect of the present disclosure and/or as a representative basis for teaching one skilled in the art to variously employ the present disclosure.

It is also to be understood that this present disclosure is not limited to the specific embodiments and methods described below, as specific components and/or conditions may, of course, vary. Furthermore, the terminology used herein is used only for the purpose of describing particular embodiments of the present disclosure and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

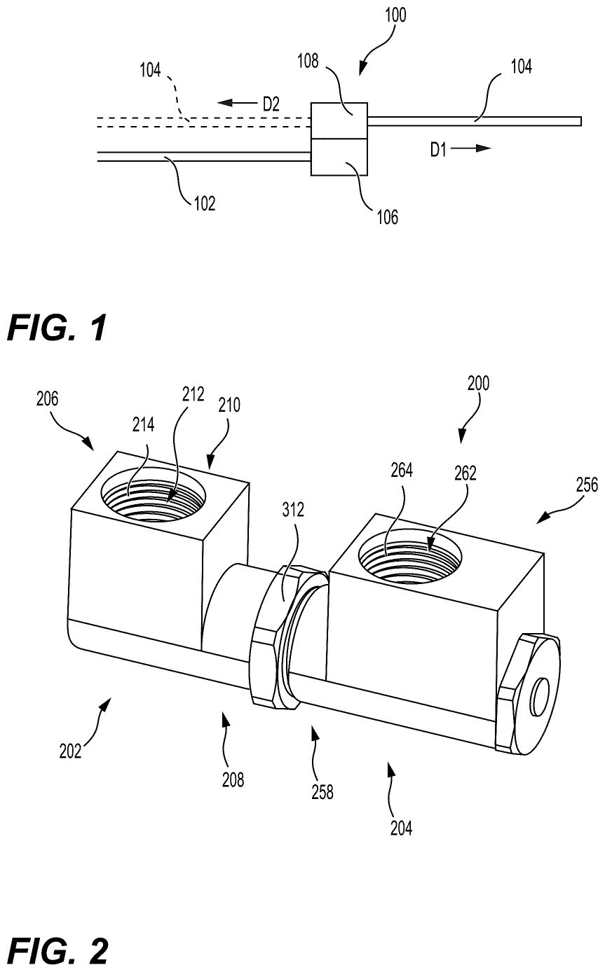

Embodiments of the disclosure provide a cable splicing device 100 structurally configured to electrically or communicatively couple (e.g., allow for the transmission of a signal) a first communication cable 102 (e.g., a coaxial cable) to a second communication cable 104 (e.g., a coaxial cable), as schematically shown in FIG. 1. In some embodiments, the cable splicing device 100 may be structurally configured to adjust the direction which the second communication cable 104 extends from the cable splicing device 100 relative to the first communication cable 102 to improve installation versatility and/or improve electrical performance.

For example, in some embodiments, the cable splicing device 100 may include a first portion 106 structurally configured to connect to the first communication cable 102 and a second portion 108 structurally configured to connect to the second communication cable 104. The second portion 108 may be movable relative to the first portion 106 to change the direction that the second communication cable 104 extends from the cable splicing device 100. For example, FIG. 1 illustrates the second communication cable extending away from the cable splicing device 100 in a first direction D1 to create a “pass through” orientation (i.e., the second communication cable extends away from the cable splicing device 100 in the same direction that the first communication cable extends into the from the cable splicing device). The second portion 108 may also be moved such that the cable splicing device is in a 180-degree orientation (i.e., the second communication cable extends away from the cable splicing device 100 in the opposite direction D2 that the first communication cable extends into the cable splicing device). In some embodiments, the angle between the first communication cable and the second communication cable may be adjusted to any angle between the pass-through orientation and the 180-degree orientation.

FIGS. 2-6 illustrate an example cable splicing device 200 according to the present disclosure. The cable splicing device 200 may be structurally configured to electrically couple (i.e., splice) the first communication cable 102 to the second communication cable 104. The cable splicing device 200 may be configured in a variety of ways.

In some embodiments, the cable splicing device 200 may include a first portion 202 and a second portion 204. The first portion 202 may include a first proximal end portion 206 and a first distal end portion 208 opposite the first proximal end portion 206. The first proximal end portion 206 may include a first connection portion 210 structurally configured to connect to the first communication cable 102. The first connection portion 210 may be configured in a variety of ways, such as for example, any known or suitable connection type for a communication cable. In some embodiments, the first connection portion 210 may include a first cable interface port 212 with internal threads 214 (e.g., a female port) and a first pin receiving portion 216.

The first proximal end portion 206 may have a first longitudinal axis A1. In some embodiments, the first cable interface port 212 and the first pin receiving portion 216 may be centered on the first longitudinal axis A1 with the first pin receiving portion 216 distal to the first cable interface port 212.

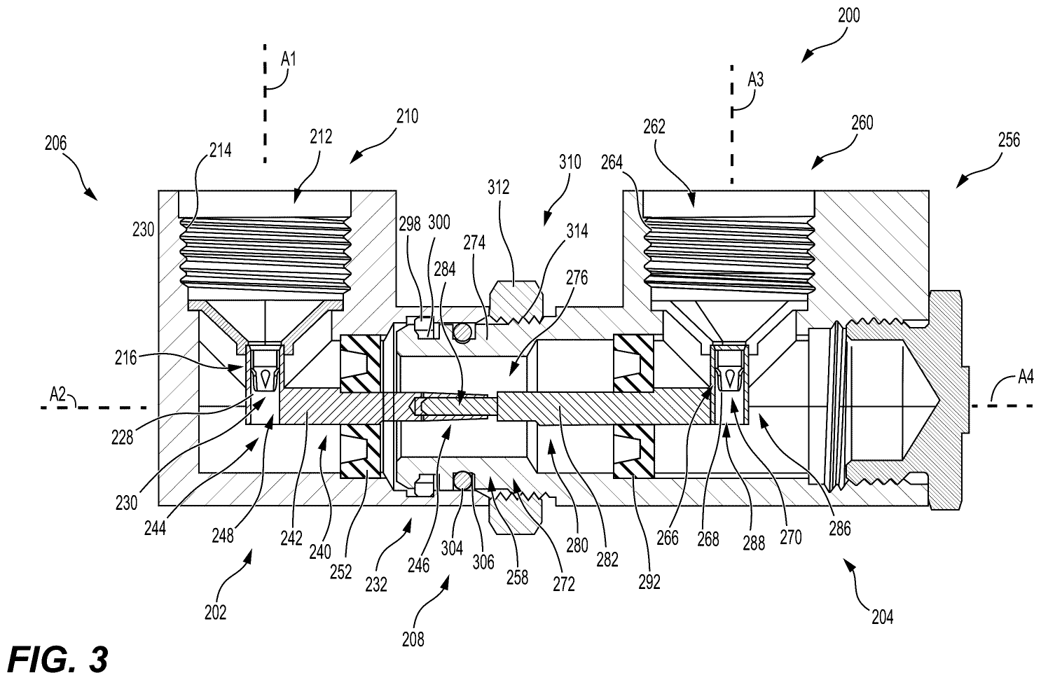

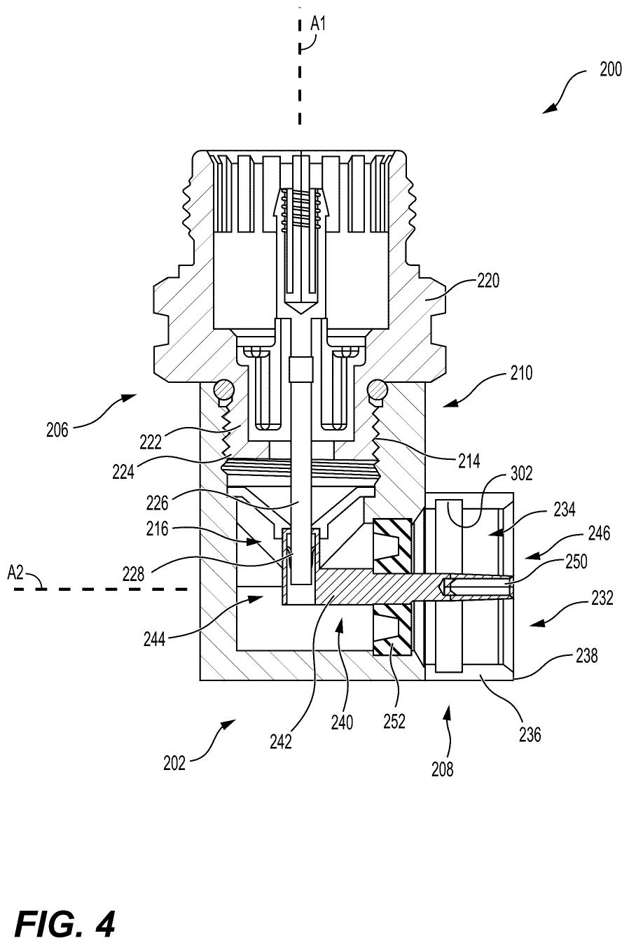

Referring to FIGS. 3-4, in some embodiments, the first communication cable 102 (FIG. 1) may have a first connector 220 which the first connection portion 210 is structurally configured to connect to. In some embodiments, the first connector 220 may include a male end portion 222 structurally configured to be received in the first cable interface port 212. In some embodiments, the male end portion 222 may include external threads 224 structurally configured to mate with the internal threads 214 of the first connection portion 210 when the male end portion 222 is received into (i.e., threaded into) the first cable interface port 212. The first connector 220 may include a conductor pin 226. The conductor pin 226 may extend into the first proximal end portion 206 and be received within the first pin receiving portion 216.

The first pin receiving portion 216 can be configured in a variety of ways. In some embodiments, the first pin receiving portion 216 may be structurally configured to contact the conductor pin 226 in a manner that forms an electrical connection between the conductor pin 226 and the first pin receiving portion 216. In some embodiments, the first pin receiving portion 216 may have a tubular shape with one or more sidewall portions 228 that tapers inward and forms a central passage 230 (FIG. 3). The sidewall portions 228 may be structurally configured to engage the conductor pin 226 when the conductor pin 226 is received through the central passage 230, as shown in FIG. 4.

The first distal end portion 208 may have a second longitudinal axis A2. In some embodiments, the second longitudinal axis A2 may extend approximately perpendicular (e.g., 90±10 degrees) to the first longitudinal axis A1. In some embodiments, the first distal end portion 208 of the first portion 202 may include a second connection portion 232 structurally configured to connect to the second portion 204. The second connection portion 232 may be configured in a variety of ways. In some embodiments, the second connection portion 232 may include a coupling port 234 (FIG. 4) structurally configured to receive a portion of the second portion 204. For example, in some embodiments, the first distal end portion 208 may include a cylindrical side wall portion 236 defining the coupling port 234 and a distal end face 238.

The first distal end portion 208 may also include a first conducting portion 240. The first conducting portion 240 may be structurally configured to electrically connect the first portion 202 to the second portion 204. The first conducting portion 240 can be configured in a variety of ways. For example, the first conducting portion 240 may include any suitable electrical conducting material (e.g., a conducting metal such as copper). In some embodiments, the first conducting portion 240 may have an elongated body portion 242 (e.g., rod, pin, shaft, block, etc.) that extends from the first pin receiving portion 216 to the first distal end portion 208.

The first conducting portion 240 may have a proximal end portion 244 and a distal end portion 246 opposite the proximal end portion 244. The proximal end portion 244 may be structurally configured to electrically couple to the first pin receiving portion 216. For example, in some embodiments, the first pin receiving portion 216 may be at least partially supported by or in contact with the proximal end portion 244. In some embodiments, the proximal end portion 244 may form a passage 248 within which the first pin receiving portion 216 is received and supported. The distal end portion 246 of the first conducting portion 240 may be structurally configured to connect to the second portion 204. In some embodiments, the distal end portion 246 may include a recess or cavity 250.

In some embodiments, the first portion 202 may include an insulating portion 252 positioned between the proximal end portion 244 and the distal end portion 246 of the first conducting portion 240. The insulating portion 252 may be configured in a variety of ways, including any suitable insulating materials and any suitable shape. In some embodiments, the insulating portion 252 may be an annular member positioned to extend around the perimeter of the elongated body portion 242 at a position between the proximal end portion 244 and the distal end portion 246.

The second portion 204 of the cable splicing device 200 may include a second distal end portion 256 and a second proximal end portion 258 opposite the second distal end portion 256. The second distal end portion 256 may include a third connection portion 260 structurally configured to connect to the second communication cable 104. The third connection portion 260 may be configured in a variety of ways, such as for example, any known or suitable connection type for a communication cable. In some embodiments, the third connection portion 260 may be structurally configured the same or similar to the first connection portion 210.

In some embodiments, the third connection portion 260 may include a second cable interface port 262 and a second pin receiving portion 266. In some embodiments, the second cable interface portion 262 may be a female port with internal threads 264. The second distal end portion 256 may have a third longitudinal axis A3. In some embodiments, the second cable interface portion 262 and the second pin receiving portion 266 may be centered on the third longitudinal axis A3 with the second pin receiving portion 266 distal to the second cable interface port 262.

The second p pin receiving portion 266 may be structurally configured to contact a conductor pin of the second communication cable 104 (e.g., configured the same or similar as to conductor pin 226 of the first communication cable 102) in a manner that forms an electrical connection between the conductor pin (not shown) of the second communication cable 104 and the second pin receiving portion 266. The second pin receiving portion 266 can be configured in a variety of ways. In some embodiments, the second pin receiving portion 266 may be structurally configured the same or similar to the first pin receiving may have a tubular shape with one or more sidewall portions 268 that tapers inward and forms a central passage 270 (FIG. 3). The sidewall portions 268 may be structurally configured to engage the conductor pin of the second communication cable 104 when the conductor pin is received through the central passage 270.

The second proximal end portion 258 may have a fourth longitudinal axis A4. In some embodiments, the fourth longitudinal axis A4 may extend approximately perpendicular (e.g., 90±10 degrees) to the third longitudinal axis A3. In some embodiments, the fourth longitudinal axis A4 may be coaxial to the second longitudinal axis A2.

In some embodiments, the second proximal end portion 258 of the second portion 204 may include a fourth connection portion 272 structurally configured to connect to the first portion 202. The fourth connection portion 272 may be configured in a variety of ways. In some embodiments, the fourth connection portion 272 may include a cylindrical sidewall portion 274 (FIG. 4) defining a passage 276. In some embodiments, the cylindrical sidewall portion 274 may be structurally configured to be received within the coupling port 234 of the first portion 202.

In some embodiments, the second portion 204 may be structurally configured to connect to the first portion 202 such that the second portion 204 is rotatable relative to the first portion 202. For example, the cylindrical sidewall portion 274 may be received within the coupling port 234 in a manner such that the second portion 204 is rotatable relative to the first portion 202. In some embodiments, the second portion 204 may be rotatable relative to the first portion 202 about the fourth longitudinal axis A4.

The second proximal end portion 258 may also include a second conducting portion 280. The second conducting portion 280 may be configured to electrically connect the second portion 204 to the first portion 202. The second conducting portion 280 can be configured in a variety of ways. For example, the second conducting portion 280 may include any suitable electrical conducting material (e.g., a conducting metal such as copper). In some embodiments, the second conducting portion 280 may have an elongated body portion 282 (e.g., rod, pin, shaft, block, etc.) that extends from the second pin receiving portion 266 to the second proximal end portion 258.

The second conducting portion 280 may have a proximal end portion 284 and a distal end portion 286 opposite the proximal end portion 284. The distal end portion 286 may be structurally configured to electrically couple to the second pin receiving portion 266. For example, in some embodiments, the second pin receiving portion 266 may be at least partially supported by or in contact with the distal end portion 286. In some embodiments, the distal end portion 286 may form a passage 288 within which the second pin receiving portion 266 is received and supported.

The proximal end portion 284 of the second conducting portion 280 may be structurally configured to connect to the first conducting portion 240 to form an electrical coupling therewith. In some embodiments, the proximal end portion 284 of the second conducting portion 280 and the distal end portion 246 of the first conducting portion 240 may be structurally configured to rotate relative to each other. For example, in some embodiments, the proximal end portion 284 may be structurally configured to be received in the recess or cavity 250 of the distal end portion 246 of the first conducting portion 240 such that an electrical coupling is formed between the proximal end portion 284 and the distal end portion 246 while the proximal end portion 284 may rotate about the fourth longitudinal axis A4 relative to the distal end portion 246.

In some embodiments, the second portion 204 may include an insulating portion 292 positioned between the proximal end portion 284 and a distal end portion 286 of the second conducting portion 280. The insulating portion 292 can be configured in a variety of ways, including any suitable insulating materials and any suitable shape. In some embodiments, the insulating portion 292 may be an annular member positioned to extend around the perimeter of the elongated body portion 282 at a position between the proximal end portion 284 and a distal end portion 286.

In some embodiments, the cable splicing device 200 may include a retaining portion 294 and sealing portion 296. The retaining portion 294 may be structurally configured to prevent, or restrict, the first portion 202 and the second portion 204 separating while also allowing the second portion 204 to rotate relative to the first portion 202. The retaining portion 294 may be configured in a variety of ways. In some embodiments, the retaining portion 294 may include a retaining ring 298 captured between an outer groove 300 (FIG. 3) on the cylindrical sidewall portion 274 of the second proximal end portion 258 of the second portion 204 and an inner groove 302 (FIG. 4) in the cylindrical side wall portion 236 of the first distal end portion 208 of the first portion 202.

The sealing portion 296 may be structurally configured to provide a seal between the first portion 202 and the second portion 204 while also allowing the second portion 204 to rotate relative to the first portion 202. The sealing portion 296 may be configured in a variety of ways. In some embodiments, the sealing portion 296 may include an O-ring 304 captured between an outer groove 306 (FIG. 3) on the cylindrical sidewall portion 274 of the second proximal end portion 258 of the second portion 204 and the cylindrical side wall portion 236 of the first distal end portion 208 of the first portion 202.

In some embodiments, the cable splicing device 200 may include a locking portion 310. The locking portion 310 may be structurally configured to selectively prevent or restrict relative rotation between the first portion 202 and the second portion 204. The locking portion 310 may be configured in a variety of ways. In some embodiments, the locking portion 310 may include a stop portion 312 structurally configured to abut the first portion 202 or the second portion 204 to prevent relative rotation therebetween. The stop portion 312 can be configured in a variety of ways.

In some embodiments, the stop portion 312 may include a jam nut. For example, in some embodiments, the locking portion 310 may include external threads 314 on the cylindrical sidewall portion 274 of the second proximal end portion 258 of the second portion 204. The stop portion 312 may threadably engage with the external threads 314 such that the stop portion 312 can be threaded along the external threads 314 to abut (i.e., be jammed against) the distal end face 238 of the first portion 202 (i.e., placing the stop 312 in a locked position). As a result, the retaining ring 298 may be forced distally (i.e., toward the second portion 204) within the outer groove 300.

As described above, the cable splicing device 200 may be structurally configured to adjust the orientation of the second cable interface port relative to the first cable interface port; and thus, adjust the direction that the second communication cable 104 extends from the cable splicing device 200 relative to the direction that the first communication cable 102 extends into the cable splicing device 200. Referring to the FIG. 2, the cable splicing device 200 may, for example, be arranged in a 180-degree orientation in which both the first cable interface port 212 and the second cable interface port 262 are facing the same direction.

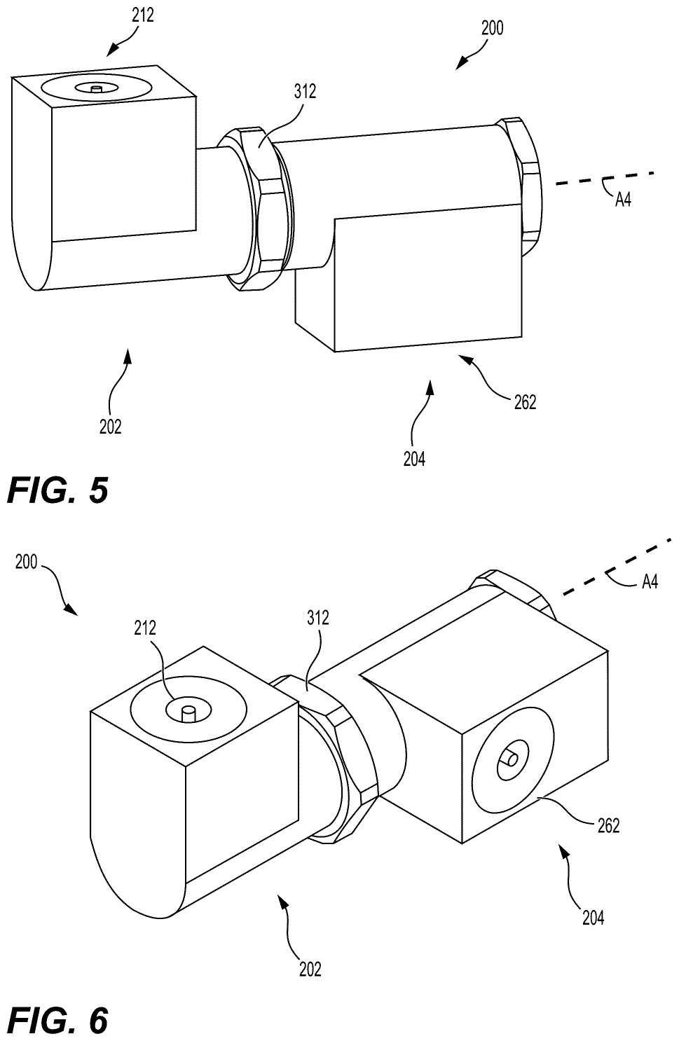

Referring to FIG. 5, the cable splicing device 200 may be arranged in a pass-through orientation in which the first cable interface port 212 and the second cable interface port 262 are facing in opposite directions. The cable splicing device 200 may be changed from the 180-degree orientation to the pass-through orientation by rotating the second portion 204 about the fourth longitudinal axis A4 180 degrees. In some embodiments, to allow rotation of the second portion 204, the stop portion 312 may be rotated to move out of engagement with the distal end face 238 of the first portion 202.

Referring to FIG. 6, the cable splicing device 200 may be arranged in a 90-degree orientation in which the first female port 212 and the second female port 262 are facing 90 degrees apart. The cable splicing device 200 may be changed from the 180-degree orientation or the pass-through orientation to the 90-degree orientation by rotating the second portion 204 90 degrees about the fourth longitudinal axis A4. In some embodiments, the second cale interface port 262 may be rotated about the fourth longitudinal axis A4 to any angle (i.e., 360-degree adjustability) relative to the first female port 212.

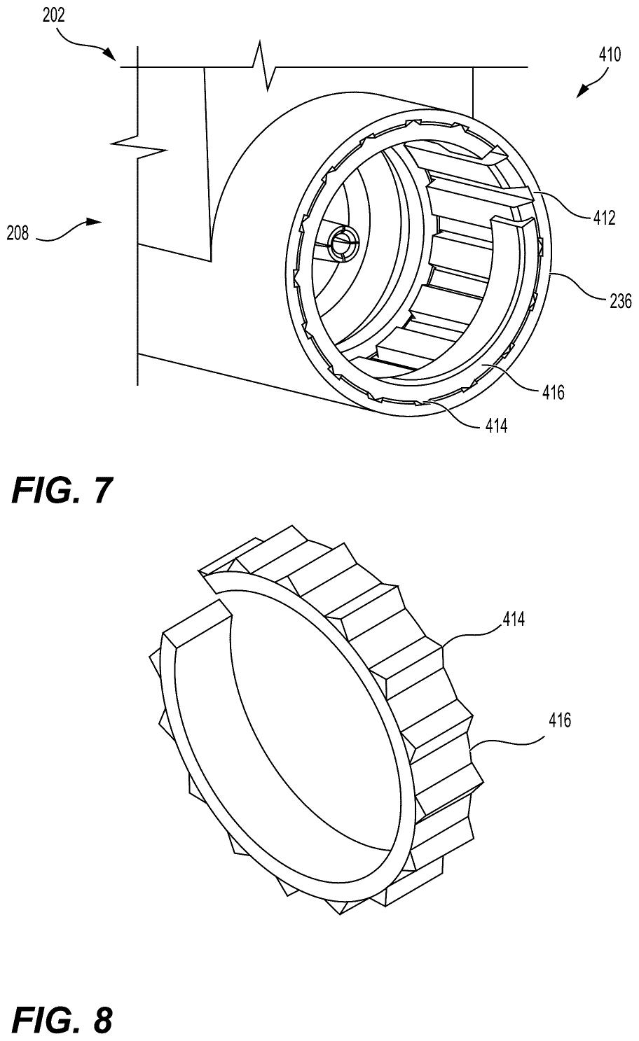

FIGS. 7-8 illustrate an example locking portion 410 for use with the cable splicing device 200. In some embodiments, the locking portion 410 may be used in conjunction with the locking portion 310 or as an alternative to the locking portion 310. The locking portion 410 may be structurally configured to prevent or resist relative rotation between the first portion 202 and the second portion 204. In some embodiments, the locking portion 410 may include a recessed portion 412 (e.g., a series of recesses, such as for example, longitudinal grooves) on the inner side of the cylindrical side wall portion 236 of the first distal end portion 208 of the first portion 202. In some embodiments, the series of recesses 412 may extend 360 degrees around the inner side of the cylindrical side wall portion 236. For example, in the illustrated embodiment, the first distal end portion 208 may include sixteen (16) recesses 412 evenly spaced around the inner surface (i.e., spaced apart by 22.5 degrees). In other embodiments, however, the number of recesses 412 may be less than or greater than sixteen.

The locking portion 410 may also include a one or more projecting portions 414 associated with the second proximal end portion 258 of the second portion 204 and structurally configured to be received in one or more of the series of recesses 412. The one or more projecting portions 414 may be configured in a variety of ways, including the shape, the size, and the number of projections.

In some embodiments, the one or more projecting portions 414 may extend radially outward from the cylindrical sidewall portion 274 of the second proximal end portion 258. In some embodiments, the one or more projecting portions 414 may be formed on a base portion 416 (e.g., a ring or annular member) that is fixed relative to the cylindrical sidewall portion 274 such that the base portion 416 may rotate with the second portion 204 about the fourth longitudinal axis. The base portion 416 may be a continuous ring or annular member or discontinuous. In some embodiments, the base portion 416 may include 15-16 projecting portions or less than 15-16 projecting portions 414. In some embodiments, each of the projecting portions 414 may have a triangular cross-section. In other embodiments, however, the cross-section of the each of the projecting portions 414 414 may be other than triangular. In some embodiments, the spacing between adjacent projecting portions 414 may match the spacing between adjacent recesses 412 such that at any rotational position of the second portion 204 relative to the first portion 202, the projecting portions 414 are either all received within corresponding recesses 412 or are all not received within corresponding recesses 412.

In some embodiments, the projecting portions 414 may be structurally configured to act as detents to resist relative rotation between the first portion 202 and the second portion 204. For example, when the projecting portions 414 are received within corresponding recesses 412, relative rotation between the first portion 202 and the second portion 204 is prevented or resisted. However, with sufficient rotational force, the projecting portions 414 or base portion 416 may deflect or deform to release the second portion 204 (i.e., move the projecting portions 414 out of the recesses 412) such that the second portion 204 can be rotated about the fourth longitudinal axis A4 to change the orientation of the second female port 262 relative to the first female port 212.

The disclosed cable splicing device may be configured to improve installation versatility. For example, having the capability to adjust an angular orientation of the second female port relative to the first female port allows the cable splicing device to be used in a variety of applications where orientation of the cables may vary. Further, eliminating unused ports may provide improved electrical performance. For example, the unused ports and corresponding internal components on a conventional four fixed port splice block may form an electrical coupling that act as antennae, which may result in a degraded signal quality. By eliminating the unused ports, the disclosed cable splicing device avoids that concern. For example, when electrically (gated return loss) tested, some conventional splice blocks have shown a return loss of 9 dB out to 3 GHz while the disclosed cable splicing device shows a return loss of 20 dB out to 3 GHz.

While at least one example, non-limiting embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A cable splicing device having cable interface ports that are configured to be rotated relative to one another to permit adjustment of a relative orientation of the cable interface ports, comprising:
a first portion having a first proximal end portion and a first distal end portion opposite the first proximal end portion, the first proximal end portion structurally configured to connect to a first communication cable;
a second portion having a second proximal end portion and a second distal end portion opposite the second proximal end portion, the second distal end portion structurally configured to connect to a second communication cable;
wherein the first proximal end portion includes a first female port and a first pin receiving portion structurally configured to connect to a first male end of the first communication cable;
wherein the second distal end portion includes a second female port and a second pin receiving portion structurally configured to connect to a second male end of the second communication cable;
wherein the first portion and the second portion are structurally configured to electrically couple the first communication cable with the second communication cable;
wherein a locking portion is structurally configured to resist rotation of the second portion relative to the first portion;
wherein the locking portion includes a stop portion threadedly coupled to the second portion and structurally configured to engage the first portion to prevent rotation of the second portion relative to the first portion;
wherein the second proximal end portion of the second portion is structurally configured to be received within a coupling port of the first distal end portion of the first portion;
wherein the second proximal end portion is configured to be retained within the coupling port by a retaining portion;
wherein the first portion includes a first conducting portion having a first proximal end portion and a first distal end portion opposite the first proximal end portion;
wherein the first proximal end portion of the first conducting portion is structurally configured to electrically couple to the first pin receptacle;
wherein the second portion includes a second conducting portion having a second proximal end portion and a second distal end portion opposite the second proximal end portion;
wherein the second distal end portion of the second conducting portion is structurally configured to electrically couple to the second pin receptacle;
wherein the first distal end portion of the first conducting portion is structurally configured to electrically couple to the second proximal end portion of the second conducting portion;
wherein the first distal end portion of the first conducting portion includes a recessed portion structurally configured to receive the second proximal end portion of the second conducting portion; and
wherein the second portion is structurally configured to rotate relative to the first portion to adjust an angular orientation of the second female port relative to the first female port so as to permit adjustment of an angular orientation of the first female port relative to the second female port and improve installation versatility and electrical performance.

2. The cable splicing device of claim 1, wherein the first proximal end portion has a first longitudinal axis, the first distal end portion has a second longitudinal axis that extends at an angle in the range of 80 degrees to 100 degrees from the first longitudinal axis, the second distal end portion has a third longitudinal axis, and the second proximal end portion has a fourth longitudinal axis that extends at an angle in the range of 80 degrees to 100 degrees from the third longitudinal axis.

3. The cable splicing device of claim 2, wherein the second portion is structurally configured to rotate relative to the first portion about the second longitudinal axis.

4. The cable splicing device of claim 3, wherein the second longitudinal axis and the fourth longitudinal axis are coaxial.

5. A cable splicing device having connecting portions that are structurally configured to rotate relative to one another to permit adjustment of a relative orientation of the connecting portions, comprising:
a first portion having a first proximal end portion and a first distal end portion opposite the first proximal end portion, the first proximal end portion having a first connecting portion structurally configured to connect to a first communication cable;
a second portion having a second proximal end portion and a second distal end portion opposite the second proximal end portion, the second distal end portion having a second connecting portion structurally configured to connect to a second communication cable;
wherein the first distal end portion is structurally configured to couple to the second proximal end portion;
wherein the first portion and the second portion are structurally configured to electrically couple the first communication cable with the second communication cable; and
wherein the first connecting portion includes a first female port and a first pin receiving portion structurally configured to connect to a first male end portion of the first communication cable;
wherein the second connecting portion includes a second female port and a second pin receiving portion structurally configured to connect to a second male end portion of the second communication cable;
wherein the first portion includes a first conducting portion having a first proximal end portion and a first distal end portion opposite the first proximal end portion;
wherein the first proximal end portion of the first conducting portion is structurally configured to electrically couple to the first pin receiving portion;
wherein the second portion includes a second conducting portion having a second proximal end portion and a second distal end portion opposite the second proximal end portion;
wherein the second distal end portion of the second conducting portion is structurally configured to electrically couple to the second pin receiving portion;
and wherein the first distal end portion of the first conducting portion is structurally configured to electrically couple to the second proximal end portion of the second conducting portion;
wherein the second portion is structurally configured to rotate relative to the first portion to adjust an angular orientation of the second connecting portion relative to the first connecting portion so as to permit adjustment of an angular orientation of the first connecting portion relative to the second connecting portion and improve installation versatility and electrical performance.

6. The cable splicing device of claim 5, wherein the first proximal end portion has a first longitudinal axis and the first distal end portion has a second longitudinal axis that extends at an angle in the range of 80 degrees to 100 degrees from the first longitudinal axis.

7. The cable splicing device of claim 6, wherein the second portion is structurally configured to rotate relative to the first portion about the second longitudinal axis.

8. The cable splicing device of claim 6, wherein the second distal end portion has a third longitudinal axis and the second proximal end portion has a fourth longitudinal axis that extends at an angle in the range of 80 degrees to 100 degrees from the third longitudinal axis.

9. The cable splicing device of claim 5, further comprising a locking portion that is structurally configured to resist rotation of the second portion relative to the first portion.

10. The cable splicing device of claim 5, wherein the second proximal end portion of the second portion is structurally configured to be received within a coupling port of the first distal end portion of the first portion, and wherein the second proximal end portion is structurally configured to be retained within the coupling port by a retaining portion.

11. A cable splicing device having connecting portions that are configured to be rotated relative to one another to permit adjustment of a relative orientation of the connecting portions, comprising:
a first portion having a first proximal end portion and a first distal end portion opposite the first proximal end portion, the first proximal end portion having a first connecting portion structurally configured to connect to a first communication cable;
a second portion having a second proximal end portion and a second distal end portion opposite the second proximal end portion, the second distal end portion having a second connecting portion structurally configured to connect to a second communication cable;
wherein the first distal end portion is structurally configured to couple to the second proximal end portion;
wherein the first portion and the second portion are structurally configured to electrically couple the first communication cable with the second communication cable; and
wherein the second portion is structurally configured to rotate relative to the first portion to adjust an angular orientation of the second connecting portion relative to the first connecting portion so as to permit adjustment of an angular orientation of the first connecting portion relative to the second connecting portion and improve installation versatility and electrical performance.

12. The cable splicing device according to claim 11, wherein the first connecting portion includes a first female port and a first pin receiving portion structurally configured to couple to a first male end portion of the first communication cable and the second connecting portion includes a second female port and a second pin receiving portion structurally configured to couple to a second male end portion of the second communication cable.

13. The cable splicing device according to claim 11, further comprising a locking portion structurally configured to resist rotation of the second portion relative to the first portion.

14. The cable splicing device according to claim 13, wherein the locking portion includes a stop portion associated with the second portion and structurally configured to engage the first portion to prevent rotation of the second portion relative to the first portion.

15. The cable splicing device according to claim 11, wherein the second proximal end portion of the second portion is structurally configured to be received within a coupling port of the first distal end portion of the first portion.

16. The cable splicing device according to claim 15, wherein the second proximal end portion is structurally configured to be retained within the coupling port by a retaining portion.

17. The cable splicing device according to claim 11,
wherein the first portion includes a first conducting portion having a first proximal end structurally configured to electrically couple to the first pin receiving portion and a first distal end portion opposite the first proximal end portion; and
wherein the second portion includes a second conducting portion having a second distal end portion structurally configured to electrically couple to the second pin receiving portion and a second proximal end portion opposite the second distal end portion.

18. The cable splicing device according to claim 17, wherein the first distal end portion of the first conducting portion is structurally configured to electrically couple to the second proximal end portion of the second conducting portion.

19. The cable splicing device of claim 11, wherein the first proximal end portion has a first longitudinal axis and the first distal end portion has a second longitudinal axis that extends at an angle in the range of 80 degrees to 100 degrees from the first longitudinal axis.

20. The cable splicing device of claim 11, wherein the second portion is structurally configured to rotate relative to the first portion about the second longitudinal axis.
